(19) United States
(12) Patent Application Publication
(10) Pub. No.: US 2015/0058220 A1
(43) Pub. Date: Feb. 26, 2015

(54) PAYMENT PRE-AUTHORIZATION

(71) Applicant: Cellco Partnership (d/b/a Verizon Wireless), Arlington, VA (US)

(72) Inventors: Carlos A. Cazanas, Bethlehem, PA (US); Victor Pagan, Breinigsville, PA (US); Kalpan S. Shah, Bridgewater, NJ (US); Phillip A. Leone, Frenchtown, NJ (US); Rikesh Modi, Edison, NJ (US)

(73) Assignee: CELLCO PARTNERSHIP (D/B/A VERIZON WIRELESS), Arlington, VA (US)

(21) Appl. No.: 13/975,701

(22) Filed: Aug. 26, 2013

(51) Int. Cl. G06Q 20/40

(52) U.S. Cl. CPC G06Q 20/40
USPC 705/44

(57) ABSTRACT

A computing device may receive account information identifying a user account and may authenticate the computing device as authorized to configure pre-authorized transactions for the identified user account. The computing device may receive pre-authorization parameters specifying limitations on transactions to be performed using a payment card associated with the user account, the limitations being separate from limitations on use of the payment card specified in a cardholder agreement associated with the payment card, and may provide a pre-authorization request to a transaction authorization server authorizing transactions performed using the payment card, the pre-authorization request including the account information and the pre-authorization parameters.

### BACKGROUND

Payment cards, such as credit cards or charge cards, allow their users to pay for goods and services with the card, with the promise of paying the card issuer at a later date. Payment cards may be issued by a bank or other card provider, and may be associated with a user who agrees to comply with a cardholder agreement. The cardholder agreement may specify terms of payment, including due dates, interest rates, credit limits, and authorized card users. When a payment transaction is requested using the payment card, the issuer may authorize the purchase, pay the merchant, and bill the cardholder for the charges. While payment cards provide convenience to users who no longer have to carry cash, payment cards lack flexibility with respect to selective allowance of card transactions. Moreover, payment cards are susceptible to fraudulent use, which may not be evident until multiple purchases are made using the payment card.

### BRIEF DESCRIPTION OF THE DRAWINGS

FIG. 1 illustrates an exemplary system facilitating payment pre-authorization.

FIG. 2 illustrates an exemplary process for the pre-authorization of a payment card by way of a pre-authorization application.

FIG. 3 illustrates an exemplary process for the network processing of a transaction request for a payment card.

FIG. 4 illustrates an exemplary process for the end-user processing of a transaction request for a payment card.

### DETAILED DESCRIPTION

An improved payment card system may be implemented using a pre-authorization application installed on a mobile device of a user. The pre-authorization application may allow a user of a payment card to pre-authorize the card for one or more upcoming transactions. For example, the application may receive parameters that may be applied to future transactions performed using the payment card, such as time limits during which the transaction must take place, spending limits, number of transaction limits, limitations on types of goods or services, and limitations on users of the card. These limitations and other specified requirements may be referred to herein as pre-authorization parameters. Based on the received information, the pre-authorization application may request a payment clearinghouse to pre-authorize the payment card to allow purchases according to the specified limitations. Upon successful pre-authorization, the payment card may be used as normal at point-of-sale terminals to make purchases that are within the specified pre-authorization parameters.

To facilitate the process of establishing payment card pre-authorization, the pre-authorization application may be configured to use the mobile device to quickly read information on the user's payment card (e.g., via technique such as near field communication (NFC) or image capture). In some cases, the pre-authorization application may require validation of the user before allowing use of the application. For example, the pre-authorization application may require the user to enter credentials, such as a personal identification number (PIN), password, thumb print, voice print, or entered swipe pattern, to be verified before access to the pre-authorization application is allowed. Validation of the user may be performed locally or using network facilities, and may involve validation of the user to use the application generally, or validation of the user to use the application to configure a payment card associated with the device or user.

On the backend to accomplish the pre-authorization, the payment clearinghouse may interact with a credit authorization service associated with the payment card. For example, the payment clearinghouse may contact the credit authorization service, and may provide the specified pre-authorization parameters on the authorization of the payment card to the credit authorization service. The transaction authorization service may accordingly maintain pre-authorization status information indicative of any pre-authorizations associated with the payment card. Thus, when the credit authorization service receives payment authorization requests for the payment card, the credit authorization service may utilize the pre-authorization status information to account for the user-specified limitations, instead of or in addition to the limitations on the payment card imposed by the credit authorization service. Advantageously, use of the payment card by a merchant may be performed transparently by the point-of-sale terminal of the merchant, without the merchant having to be aware of the existence of the pre-authorization process and without the merchant requiring any additional equipment to take advantage of the pre-authorization functionality.

The pre-authorization may also provide certain advantages to the cardholder. For example, because pre-authorization may be required before purchases may be made using the payment card, there is limited risk of unauthorized use of the payment card if it is stolen or misplaced and found by another. Moreover, a cardholder may be able to pre-authorize one or more users to be able to complete only certain transactions (e.g., allow a child to purchase gas or dinner but not a television), without otherwise affecting the card credit limit or other overall card features.

In some examples, the merchant may utilize an enhanced point-of-sale terminal configured to support additional identity check features according to the pre-authorization. For example, the point-of-sale terminal may receive information from the credit authorization service, such as a picture of a user pre-authorized to use the payment card based on interaction with the payment clearinghouse. By verifying the information received by the point-of-sale terminal, the system may be able to provide yet another factor of authentication to the payment card system.

While the disclosure uses payment cards in many examples, the pre-authorization techniques described herein may be applicable to other types of payment systems or authorization systems making use of payment credentials to authorize transactions with user accounts.

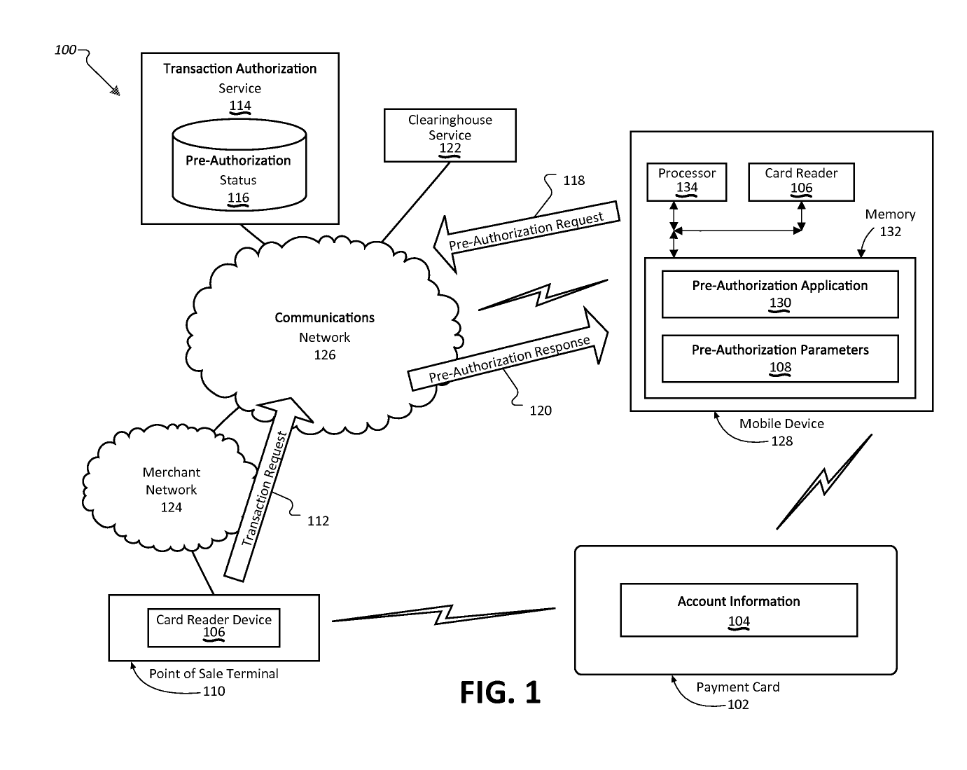

FIG. 1 illustrates an exemplary system 100 facilitating payment pre-authorization. The system 100 includes a payment card 102 having associated account information 104 and a mobile device 128 configured to receive information from the payment card 102 using a card reader device 106. The system 100 further includes a merchant network 124 having one or more point-of-sale terminals 110 configured to provide transaction requests 112 to a transaction authorization service 114 to authorize transactions that are pre-authorized by a clearinghouse service 122. The system 100 also includes a communications network 126 connected to the merchant network 124 over which the transaction authorization service 114 is accessible. A pre-authorization application 130 installed on a memory 132 of the mobile device 128 may be executed by a processor 134 of the mobile device 128 to facilitate the pre-authorization of the payment card 102 with the clearinghouse service 122 over the communications network 126. The system 100 may take many different forms and includes multiple and/or alternate components and facilities. While an exemplary system 100 is shown in FIG. 1, the exemplary components illustrated of the system 100 are not intended to be limiting. Indeed, additional or alternative components and/or implementations may be used.

The payment card 102 may be any type of card or other object that may be used by a cardholder to perform remotely-authenticated transactions such as payment for goods or services. Examples of payment cards 102 may include credit cards, debit cards (where funds are drawn from a bank account), charge cards (where the user pays the balance in full each month), automatic teller machine (ATM) cards (that may be used in ATM machines), and stored-value cards/gift cards or other pre-paid cards (where funds may be associated with a card and not necessarily with another account) using remote authentication.

Payment cards 102 may be associated with account information 104 that may be used to identify the payment card 102 when performing a payment transaction. As one example, payment cards 102 may be associated with sixteen digit decimal numbers allocated in accordance with International Organization for Standardization (ISO)/International Electrotechnical Commission (IEC) card numbering standard 7812. As other examples, the payment cards 102 may be associated with other numeric values, alphabetic values, images, sequences of information, or any other type of information sufficient to identify account information 104 of the payment card 102. The account information 104 may include additional information as well, such as a name of the cardholder, address information of the cardholder, an expiration date indicative of when the payment card 102 may no longer be used, and additional security code information used to verify the identity of the payment card 102 (e.g., for transactions where the card is not present at a merchant).

The account information 104 may be written on, imprinted on, or otherwise affixed to the payment card 102 in a manner facilitating the reading of the account information 104 by card reader devices 106. As some examples, the payment card 102 may include a magnetic stripe on which account information 104 is magnetically encoded for reading by a magnetic stripe reader device 106, integrated circuit components having electrical contacts configured to interface with a contact card reader device 106 to provide the account information 104 via the contacts, or an NFC chip configured to interact with an NFC card reader device 106 to provide the account information 104. As another example, an image capture card reader device 106 may be configured to visually capture account information 104 located on the payment card 102, such as bar codes, or numerical or other information visible on the payment card 102 itself.

The pre-authorization parameters 108 may include information used to limit what transactions may be able to be performed using the payment card 102 or the account with which the payment card 102 is associated, separate from limitations on use of the payment card 102 or account with respect to the cardholder agreement. Transactions that are allowable based on conformance with the pre-authorization parameters 108 may be referred to as pre-authorized transactions. The pre-authorization parameters 108 may include one or more of time limits after which transactions may be denied, spending limits over which transactions may be denied, and a number of transaction limit over which transactions may be denied, as some examples.

For example, the pre-authorization parameters 108 may include limitations on merchants or categories of merchant with which goods or services may be purchased. To do so, the pre-authorization parameters 108 may be configured to specify limitations according to the merchant identifier or the category of merchant. A merchant identifier is a unique identifier assigned to a merchant account to allow for unique identification of the merchant in payment processing transactions, such as those performed using a payment card 102. For instance, information such as doing-business-as name and business address may be associated with the merchant identifier in a data record of a payment processor or other entity. A merchant category code may further be associated with the merchant in the data record, and may be used to classify the business by the type of goods or services it provides, for purposes such identification of which merchant transactions may be taxable. As one example, institutions in the payment card 102 industry may assign a merchant category code to a merchant when the merchant is set up to accept transactions using payment cards 102, where the merchant category code is indicative of the type of the majority of the transactions of the merchant. Exemplary merchant category codes include 5411 (Grocery Stores/Supermarkets), 5814 (Fast Food Restaurants), 5111 (Office Supplies), 7299 (Dog Grooming Services) and 5735 (Record Stores). For example, to promote healthy eating, pre-authorization parameters 108 may be set up to specify that $500/month may be spent at merchant category 5411, but only $50/month at merchant category 5814.

As another example, the pre-authorization parameters 108 may specify limitations specific to a particular user or users of the payment card 102. To distinguish between the users of the payment card 102, the pre-authorization parameters 108 may specify credentials to be received upon use of the payment card 102 when performing a transaction. As one example, the pre-authorization parameters 108 may include multiple PINs for a single payment card 102, such that each PIN is associated with different user pre-authorization parameters 108 specifying different spending limits or other limitations. For instance, one PIN of the payment card 102 may allow for withdrawals of limited amounts, frequency, or timing (e.g., a limit of $100 per day), while a second PIN may allow for different transactions to be performed (e.g., a limit of $1000 per day, $500 to spend at any one business regardless of merchant identifier or merchant category, but a limit of $150 to spend on food merchant category 5411, etc.).

The pre-authorization parameters 108 may also specify secondary validations of a user of the payment card 102 to confirm the identity of the pre-authorized user, such as a request for visual verification of a picture of an approved user by merchant personnel or a requirement for the user to enter credentials such as a PIN, passcode or swipe code, or even biometric information such as a thumbprint or retinal scan. In some cases, secondary validations may be requested for all transactions, while in other cases, secondary validations may be requested only for transactions exceeding a certain amount, or transactions for certain merchant identifiers or category of merchant. In some cases, the pre-authorization parameters 108 may specify multiple secondary validations, such as the entry of a PIN in combination with receipt of a thumbprint. In cases in which multiple secondary validations are requested but only a portion of the secondary validations match (e.g., correct thumbprint but incorrect PIN, correct PIN but incorrect thumbprint), the pre-authorization parameters 108 may be configured to either deny all transactions, or specify fallback minimum transaction limits that may be used. For instance if a user forgets his or her PIN (or if the PIN is changed to deny the user access to additional spending limits), but still has a correct thumb print, he or she may still be able to be pre-authorized parameters 108 utilizing a defined base of pre-authorized parameters 108 for the user. As another example, if the user has the correct PIN, but does not have the correct thumbprint (e.g., perhaps the payment card 102 and PIN has been stolen), then the pre-authorized parameters 108 may be configured to deny all transactions, or allow transactions within a low limit and alert cardholder and/or authorities.

The point-of-sale terminal 110 may be one example of a device including a card reader device 106. Point of sale terminals 110 may include various types of devices, such as dedicated terminals at the checkout area of businesses, portable terminal devices configured to connect to a transaction authorization service 114, card reader device 106 attachments to mobile devices 128, or even Internet merchants who receive account information 104 without physical presence of the payment card 102 at the merchant.

The point-of-sale terminal 110 may be configured to utilize the card reader device 106 to retrieve account information 104 from a payment card 102. The received account information 104 may be included in a transaction request 112 to send to a transaction authorization service 114. Based on the request 112, the point-of-sale terminal 110 may receive a response from the transaction authorization service 114 informing the point-of-sale terminal 110 whether the transaction should be allowed or denied. The transaction request 112 to the transaction authorization service 114 may further include additional information, such as an amount of a purchase being requested or other information about the transaction. In some cases, the point-of-sale terminal 110 may provide additional functionality, such as an interface configured to receive a signature from the purchaser, or an interface to receive further information regarding the transaction, such as assent to a proposed transaction amount, or input of an additional security code associated with the payment card 102.

The transaction authorization service 114 may be configured to receive the transaction request 112, and to provide a result responsive to the request indicative of whether the transaction request 112 is approved. As one aspect, the processing of the transaction request 112 may include allowing or denying the transaction based on a determination that the payment card 102 is able to perform the transaction according to account information available to the transaction authorization service 114, such as outstanding balance, transaction amount, past due status, etc.

The clearinghouse service 122 may be configured to facilitate the pre-authorization of payment cards 102 with the transaction authorization service 114. To do so, the clearinghouse service 122 may be configured to receive pre-authorization requests 118 specifying pre-authorization parameters 108 associated with a payment card 102 for upcoming transactions. The clearinghouse service 122 may be further configured to identify a transaction authorization service 114 configured to process the received pre-authorization request 118, and communicate the specified pre-authorization parameters 108 to the identified transaction authorization service 114.

The transaction authorization service 114 may be configured to maintain pre-authorization status 116 indicative of what transactions are pre-authorized for which payment cards 102, and what secondary validations are requested. For example, the transaction authorization service 114 may be configured to receive pre-authorization requests 118 including pre-authorization parameters 108, and set the pre-authorization status 116 according to the received pre-authorization parameters 108. The transaction authorization service 114 may be further configured to provide pre-authorization responses 120 indicative of whether the pre-authorization request 118 was successful. For example, if the pre-authorization request 118 includes pre-authorization parameters 108 incompatible with the payment card 102 (e.g., requests a payment amount disallowed by the cardholder agreement), then the pre-authorization responses 120 may indicate that the pre-authorization requests 118 is denied.

Thus, in addition to ensuring that the transaction request 112 conforms to the account information of the payment card 102, the transaction authorization service 114 may also ensure that the payment card 102 is pre-authorized to perform the transaction according to the pre-authorization status 116. The transaction authorization service 114 may also be configured to update the pre-authorization status 116 based on the result of the transaction request 112. For instance, if a predetermined number of requests are pre-authorized, receipt or approval of a transaction request 112 for a payment card 102 may decrement the allowable number pre-authorized transactions for the payment card 102 indicated by the pre-authorization status 116.

In some cases, the clearinghouse service 122 may further support authentication of a requesting device of a pre-authorization request 118. For example, the clearinghouse service 122 may be configured to ensure that the requesting device is authorized to pre-authorize transactions for a specified payment card 102. The clearinghouse service 122 may validate credentials received from the requesting device, such as username/password, or a unique identifier of a user or of a device connected to the communications network 126 from which the request may originate (e.g., a mobile device number or other unique identifier of a mobile device 128).

Use of a clearinghouse service 122 may provide a common point of access for the provisioning of pre-authorization parameters 108 to one or more transaction authorization services 114. In other examples, however, it is possible for some or all of the functionality of the clearinghouse service 122 to be incorporated into the transaction authorization service 114.

The point-of-sale terminal 110 may be configured to connect to and communicate over the merchant network 124. Exemplary merchant networks 124 may include a local-area network (LAN) such as an IEEE 802.11 network, or a personal-area network (PAN) such as an IEEE 802.15.4, Zigbee, Z-Wave or Bluetooth network connection, or a wired Ethernet network as some examples. In many cases, the point-of-sale terminal 110 may have access to the merchant network 124, but other devices such as devices of the customer (e.g., mobile devices 128, etc.) may be denied access to the merchant network 124 to preserve network security.

The communications network 126 may be in communication with the merchant network 124, and may be configured to transport data between devices on the communications network 126, such as one or more point-of-sale terminals 110, the transaction authorization service 114, and the clearinghouse service 122. To do so, the communications network 126 may provide communications services, such as packet-switched network services (e.g., Internet access, VoIP communication services), to the devices connected to the communications network 126. Exemplary communications networks 126 may include the PSTN, a VoIP network, a VoLTE (Voice over LTE) network, a cellular telephone network, a fiber optic network, and a cable television network. To facilitate communications, communications devices on the communications network 126 may be associated with unique device identifiers being used to indicate, reference, or selectively connect to the identified device on the communications network 126. Exemplary types of device identifiers may include telephone numbers, mobile device numbers (MDNs), common language location identifier (CLLI) codes, internet protocol (IP) addresses, input strings, and universal resource identifiers (URIs), as some examples.

The mobile device 128 may be any of various types of device that may be configured to facilitate the providing of pre-authorization parameters related to a payment card 102 to the clearinghouse service 122. Exemplary mobile devices 128 may include laptop computers, tablet devices, or smartphone devices, as some examples.

The mobile device 128 may be configured to utilize a card reader device 106 to read account information 104 from the payment card 102. The mobile device 128 may further include a pre-authorization application 130 stored on a memory 132 of the mobile device 128 that may be executed by one or more processors 134 of the mobile device 128. When executed, the pre-authorization application 130 may be configured to send pre-authorization requests 118 to the clearinghouse service 122 to set the pre-authorization status 116 of the payment card 102 at the transaction authorization service 114. The pre-authorization requests 118 may include pre-authorization parameters 108 received from the user as well as account information 104 associated with the payment card 102. In some cases, the pre-authorization parameters 108 may be received as input to the mobile device 128 using user interface elements of the mobile device 128, such as device buttons, touch screen, microphones, etc., while in other cases one or more pre-authorization parameters 108 may be retrieved from user or device settings. The pre-authorization application 130 may be further configured to receive pre-authorization responses 120 indicative of whether the pre-authorization parameters 108 were successfully applied, as well as other status messages, such as whether unauthorized transactions were attempted using the payment card 102.

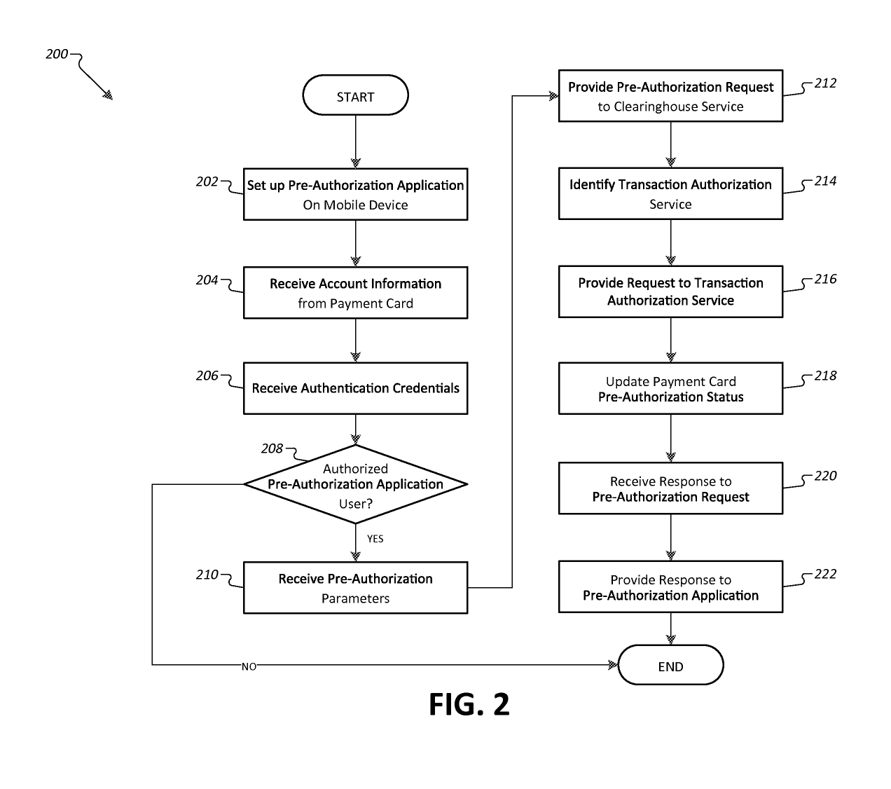

FIG. 2 illustrates an exemplary process 200 for the pre-authorization of a payment card 102 by way of a pre-authorization application 130. The process 200 may be implemented at least in part by a mobile device 128 connected to a communications network 126 and configured to execute the pre-authorization application 130 by a processor 134 of the mobile device 128.

In block 202, the pre-authorization application 130 is set up on the mobile device 128. In some cases, the pre-authorization application 130 may be preinstalled on a memory 132 of the mobile device 128 as shipped, while in other cases the user may install the pre-authorization application 130 on a memory 132 of the mobile device 128, such as via Internet download from an application store. In some cases, the setup of the pre-authorization application 130 may further include association of the mobile device 128 or a user of the mobile device 128 with a payment card 102 account. This association may be performed, for example, using an administrative mode of the pre-authorization application 130, in which the mobile device 128 may be paired with the payment card account 102. In some examples, administrative mode may be entered, for example, through entry of a passcode or other user credentials of an administrative user having rights to associate the payment cards 102 with mobile devices 128 (e.g., a user having additional administrative privileges, in some cases the primary cardholder). In some examples, the pre-authorization application 130 may validate received administrative credentials locally (e.g., for validation of a swipe pattern lock screen), while in other examples, the pre-authorization application 130 may utilize a remote device such as the clearinghouse service 122 to validate the received administrative credentials (e.g., for validation of a username/password pair). As another possibility, the association may be performed by the pre-authorization application 130 providing a request to the clearinghouse service 112 for pairing of the mobile device 128 with the payment card account 102. The pairing request may be approved or denied based on information included in the request, queried by the clearinghouse service 122, and/or according to unique identifiers identifying the mobile devices 128 such as phone number of the mobile device 128. This association of the payment card 102 to mobile device 128 may be performed to later ensure that the mobile device 128 or a user of the mobile device 128 is indicated as being able to utilize the pre-authorization application 130 for the associated payment card 102 account. For instance, the association may be provided to the clearinghouse service 122 for verification of received pre-authorization requests 118. In some cases, setup may also include providing information about the clearinghouse service 122 to the mobile device such as a clearinghouse service 122 server address.

In block 204, the pre-authorization application 130 receives account information 104 from the payment card 102. As one example, the pre-authorization application 130 may be configured to use a card reader device 106 of the mobile device 128 to read information on the user's payment card 102 by way of near field communication (NFC). In such examples, a user may place the payment card 102 in proximity of the mobile device 128 to facilitate the retrieval of account information 104 by the pre-authorization application 130 from the payment card 102. As another example, the pre-authorization application 130 may be configured to use an image capture card reader device 106 to visually capture account information 104 located on the payment card 102, such as bar codes, account numbers, or other information visible on the payment card 102 itself.

In block 206, the pre-authorization application 130 receives user credentials. For example, the pre-authorization application 130 may require user authorization before allowing access to the pre-authorization application 130. For instance, the pre-authorization application 130 may request a user to enter credentials, such as, to use some non-limiting examples, a PIN, password, thumb print, voice print, or entered swipe pattern on a touch screen of the mobile device 128.

In decision point 208, the pre-authorization application 130 determines whether the user is authorized to use the pre-authorization application 130 for the payment card 102. In some examples, the pre-authorization application 130 may validate received user credentials locally (e.g., for validation of a swipe pattern lock screen), while in other examples, the pre-authorization application 130 may utilize a remote device such as the clearinghouse service 122 to validate the received credentials (e.g., for validation of a username/password pair). If the pre-authorization application 130 determines that the user is able to utilize the pre-authorization application 130 to pre-authorize transactions for the payment card 102, control passes to block 210. Otherwise, the process 200 ends.

In block 210, the pre-authorization application 130 receives pre-authorization parameters 108. For example, the pre-authorization application 130 may be configured to cause the mobile device 128 to provide a user interface through which a user may specify one or more of time limits after which transactions may be denied, spending limits over which transactions may be denied, a number of transaction limit over which transactions may be denied, limitations on types of goods or services that may be purchased, limitations on users of the payment card 102, and any secondary validations that may be requested. The received pre-authorization parameters 108 may include one or more of: the addition of new limitations, the modification of existing limitations, and the removal of existing limitations.

In block 212, the pre-authorization application 130 provides a pre-authorization request 118 to a clearinghouse service 122. For example, the pre-authorization application 130 may be configured to cause the mobile device 128 to provide a request 118 to the clearinghouse service 122 specifying the received account information 104 and pre-authorization parameters 108 associated with a payment card 102. As some examples, the pre-authorization request 118 may request the clearinghouse service 122 to pre-authorize the payment card 102 for one or more of a predetermined period of time (e.g., 15 minutes, 30 minutes), for a number of upcoming transactions (e.g., one transaction, three transactions), for specific goods (e.g., for restaurants, for home improvement items), or for a particular user (e.g., for a main user of the payment card 102, for a child borrowing the payment card 102, etc.).

In block 214, the clearinghouse service 122 identifies a transaction authorization service 114 configured to process the received pre-authorization request 118. For example, the clearinghouse service 122 may identify a type of the payment card 102 based on the account information 104, and may direct the request 118 to a transaction authorization service 114 associated with payment cards 102 of the identified type. As another example, the clearinghouse service 122 may identify the transaction authorization service 114 to receive the pre-authorization request 118 according to an algorithm configured to provide load balancing over a plurality of transaction authorization services 114. As yet a further example, all pre-authorization requests 118 may be routed to a single transaction authorization service 114 or to a single collection of transaction authorization services 114.

In block 216, the clearinghouse service 122 provides the pre-authorization request 118 to the identified transaction authorization service 114. The pre-authorization request 118 to the transaction authorization service 114 may include the account information 104 as well as the pre-authorization parameters 108.

In block 218, the transaction authorization service 114 updates the pre-authorization status 116 associated with the payment card 102. For example, the transaction authorization service 114 may update the pre-authorization status 116 to indicate what future transactions received by the transaction authorization service 114 are pre-authorized according to the pre-authorization parameters 108, and which are not and thus should be denied. The transaction authorization service 114 may further validate that the pre-authorization request 118 includes pre-authorization parameters 108 compatible with the payment card 102, and may deny pre-authorization requests 118 that request authorization for transactions that are impermissible according to the cardholder agreement.

In block 220, the clearinghouse service 122 receives a pre-authorization response 120 responsive to the processing of the pre-authorization request 118 by the transaction authorization service 114. For example, the clearinghouse service 122 may receive information in a response 120 from the transaction authorization service 114 acknowledging receipt of the pre-authorization request 118 or further information indicative of whether the pre-authorization request 118 was granted or denied.

In block 222, the clearinghouse service 122 provides the pre-authorization response 120 to the pre-authorization application 130 of the mobile device 128. The pre-authorization application 130 may accordingly provide the pre-authorization response 120 to the pre-authorization request 118 to a user of the mobile device 128. In some examples, the pre-authorization responses 120 may be sent to multiple mobile devices 128. For example, the pre-authorization response 120 may be sent to the mobile devices 128 of all of the users associated with the payment card 102. As another example, the pre-authorization responses 120 may be sent to a mobile device 128 of a user indicated as being an administrative user or primary cardholder of the payment card (instead of or in addition to the pre-authorization response 120 being sent to the mobile device 128 of the user requesting the pre-authorization). As yet a further example, the pre-authorization responses 120 may be sent to users only if the transaction exceeds certain criteria (e.g., where the transaction exceeds a threshold amount, only for transactions at certain merchants or categories of merchant, only for transactions at certain times of day, etc.). Or, the pre-authorization responses 120 may be always sent to certain users if the transaction does not exceed the criteria (e.g., only to an administrative user or primary cardholder of the payment card, only to the mobile device 128 of the user requesting the pre-authorization, only to both), but to more users if the transaction does exceeds the criteria (e.g., to all users to inform the users of large transactions being placed on the payment card 102). After block 222, the process 200 ends.

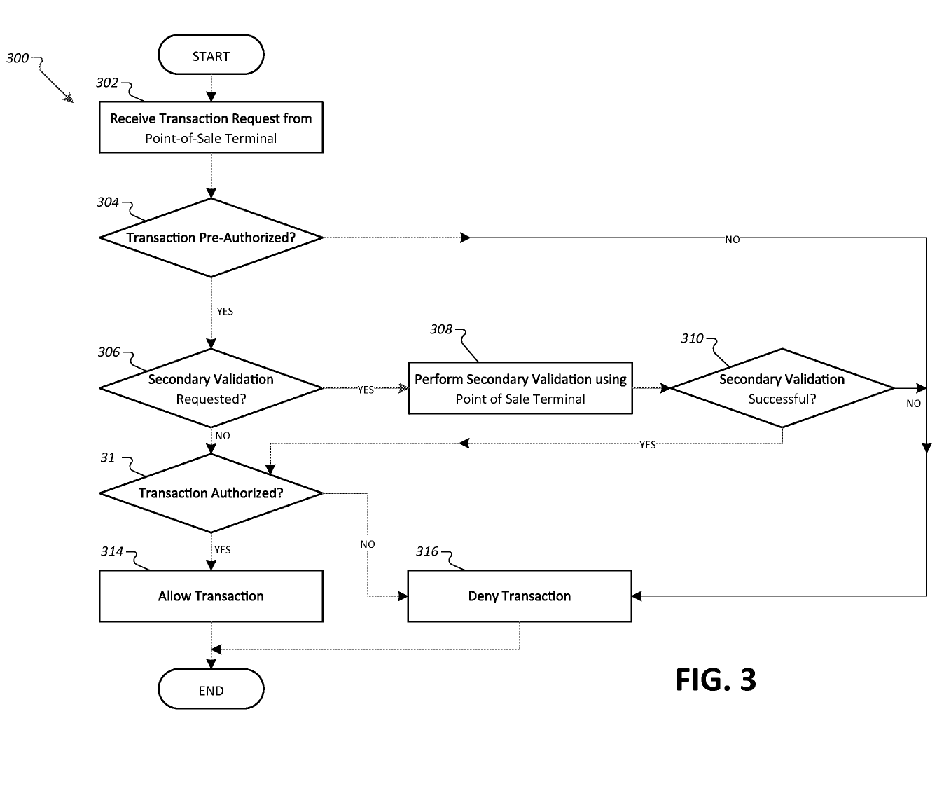

FIG. 3 illustrates an exemplary process 300 for network processing of a transaction request 112 for a payment card 102. The process 300 may be performed by a transaction authorization service 114 in communication with a point-of-sale terminal 110.

In block 302, the transaction authorization service 114 receives a transaction request 112. For example, a user of a payment card 102 may swipe the payment card 102 through a card reader device 106 of the point-of-sale terminal 110 to retrieve account information 104, and may request for a transaction to be performed using the payment card 102. To process the transaction, the point-of-sale terminal 110 may create a transaction request 112 including the account information 104, an amount of the transaction, and other information (e.g., date and time, merchant identifier, an entered PIN, etc.), and may provide the transaction request 112 to the transaction authorization service 114.

In decision point 304, the transaction authorization service 114 determines whether the transaction request 112 is pre-authorized. For example, the transaction authorization service 114 may validate the transaction request 112 to determine, based on the pre-authorization status 116 associated with the payment card 102, whether the transaction request 112 is pre-authorized. For instance, the transaction authorization service 114 may validate one or more of whether the transaction request 112 is within a period of time within which the payment card 102 is pre-authorized, whether the transaction request 112 is within a number of pre-authorized transactions, whether the transaction request 112 is for specific type of goods that are pre-authorized, or whether the transaction request 112 is from a particular user that is pre-authorized for the payment card 102. If the transaction request 112 fits within the pre-authorization status 116 associated with the payment card 102, control passes to decision point 306. Otherwise, control passes to block 316.

In decision point 306, the transaction authorization service 114 determines whether to perform secondary validation. The pre-authorization parameters 108 may specify secondary validations of a user of the payment card 102 to confirm the identity of the pre-authorized user, such as a request for visual verification of a picture of an approved user by merchant personnel or a requirement for the user to enter credentials such as a PIN, passcode or swipe code, or even biometric information such as a thumbprint or retinal scan. For example, in some cases the point-of-sale terminal 110 may include additional functionality useful for performing the additional validation of the transaction request 112, such as a thumbprint, retina, or other biometric scanner or a screen configured to receive a picture of the approved user in the point-of-sale terminal 110. In other cases, the point-of-sale terminal 110 may be a simple point-of-sale terminal 110 without additional pre-authorization functionality. If the point-of-sale terminal 110 supports secondary validation, and further if the pre-authorization status 116 requests secondary validation, control passes to block 308. Otherwise control passes to decision point 312. As a further example, in cases in which secondary validation may be required according to the pre-authorization parameters 108, but not possible due to limitations of the point-of-sale terminal 110, then control may pass to block 316 (not shown in FIG. 3).

In block 308, the transaction authorization service 114 performs secondary validation using the point-of-sale terminal 110. As one example, the pre-authorization status 116 of the payment card 102 may request visual verification of the user, and the transaction authorization service 114 may provide a picture of the pre-authorized user to the point-of-sale terminal 110 for validation by a cashier or other merchant personnel aiding in the transaction. The point-of-sale terminal 110 may receive input from the merchant personnel indicative of whether the user is a pre-authorized user. As another example, the pre-authorization status 116 of the payment card 102 may request input of additional credentials, such as an additional code or swipe pattern assigned to a user as part of the pre-authorization parameters 108.

In block 310, the transaction authorization service 114 or point-of-sale terminal 110 determines whether the secondary validation is successful. To use the example of visual validation of the user, the confirmation of the user by the merchant may be provided to the transaction authorization service 114, while in other cases, merchant personnel may simply abort the transaction if the user does not match. As other example, the point-of-sale terminal 110 may provide the additional credentials to the transaction authorization service 114 for remote validation. If the secondary validation is successful, control passes to decision point 312. Otherwise, control passes to block 316.

In decision point 312, the transaction authorization service 114 determines whether the transaction request 112 is authorized. For example, the transaction authorization service 114 may validate the limitations on the payment card 102 imposed by the credit authorization service. These limitations may include, for instance the credit limit of the payment card 102, whether the payment card 102 has a past due balance, or other standard criteria for the payment card 102 unrelated to the pre-authorization. If the transaction indicated by the transaction request 112 is authorized, control passes to block 314. Otherwise, control passes to block 316.

In block 314, the transaction authorization service 114 allows the transaction. For example, the transaction authorization service 114 may provide a response to the point-of-sale terminal 110 indicating that the transaction is accepted. The transaction authorization service 114 may further update the pre-authorization status 116 associated with the payment card 102 to indicate that a transaction was performed. For instance, if the pre-authorization parameters 108 specified that only a certain number of transactions are pre-authorized, then the transaction authorization service 114 may decrement in the pre-authorization status 116 the number of future transactions that may be pre-authorized for the payment card 102. As one case, if only a single transaction was pre-authorized according to the pre-authorization parameters 108, then further transactions may be denied without the submission of further pre-authorization parameters 108 to the transaction authorization service 114. In some cases, a confirmation or other update message may be provided to the pre-authorization application 130 (e.g., to the user of the mobile device 128 that provided the pre-authorization parameters 108) indicative of the processing of a pre-authorized transaction. After block 314, the process 300 ends.

In block 316, the transaction authorization service 114 denies the transaction. For example, the transaction authorization service 114 may provide a response to the point-of-sale terminal 110 indicating that the transaction is not accepted. It should be noted that in some examples, the point-of-sale terminal 110 may not be given information indicative of why the transaction was denied, such as whether the transaction failed pre-authorization or failed authorization. In some cases, a confirmation or other update message may be provided to the pre-authorization application 130 (e.g., to the user of the mobile device 128 of an owner of the payment card 102) indicative of the failed pre-authorization. Such information may be useful in notifying the user of unauthorized use of the payment card 102. After block 316, the process 300 ends.

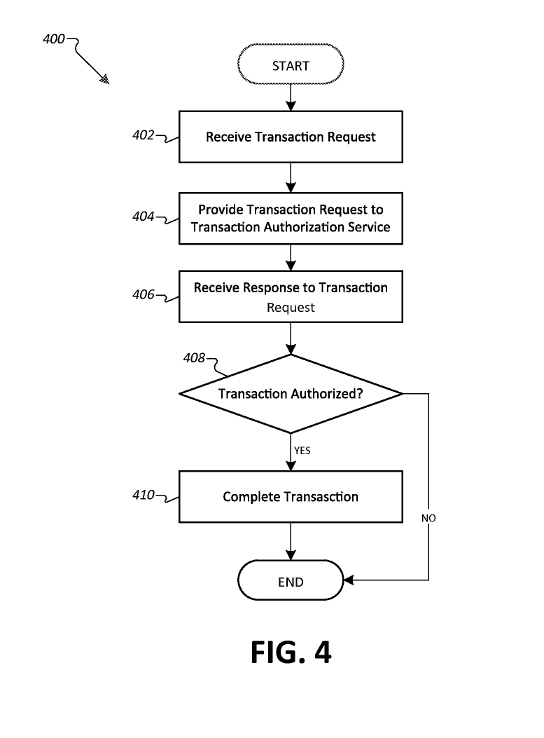

FIG. 4 illustrates an exemplary process 400 for the end-user processing of a transaction request 112 for a payment card 102. The process 400 may be performed by a point-of-sale terminal 110 in communication with a transaction authorization service 114.

In block 402, the point-of-sale terminal 110 receives a transaction request 112. For example, a user of a payment card 102 may swipe the payment card 102 through a card reader device 106 of the point-of-sale terminal 110 to retrieve account information 104, and may request for a transaction to be performed using the payment card 102.

In block 404, the point-of-sale terminal 110 provides the transaction request 112 to the transaction authorization service 114. For example, the point-of-sale terminal 110 may provide in the transaction request 112 the account information 104 and an amount of the transaction to the transaction authorization service 114. The transaction authorization service 114 may process the transaction request 112 as discussed in detail above with respect to the process 300. As one example, for point-of-sale terminals 110 that support secondary validation and for users for whom secondary validation is requested, such valuation may be performed as part of processing of the transaction request 112 as discussed above.

In block 406, the point-of-sale terminal 110 receives a response to the transaction request 112. For example, the point-of-sale terminal 110 may receive a response from the transaction authorization service 114 indicative of whether the transaction was allowed or denied. It should be noted that in many cases, for denied transactions the point-of-sale terminal 110 may be unaware of whether the transaction was denied because it was not authorized, or because it was not pre-authorized.

In decision point 408, the point-of-sale terminal 110 determines whether to proceed with the transaction. For example, if the response from the transaction authorization service 114 indicates that the transaction is allowed, control passes to block 410. Otherwise, the process 400 ends.

In block 410, the point-of-sale terminal 110 completes the transaction. After block 410, the process 400 ends.

Thus, by using a pre-authorization application 130 installed on a user's mobile device 128, the user may pre-authorize a payment card 102 for one or more upcoming transactions. For example, the user may specify pre-authorization parameters 108 including one or more of time limits during which the transaction must take place, spending limits, number of transaction limits, limitations on types of goods or services, and/or limitations on users of the payment card 102. By providing the pre-authorization parameters 108 to a clearinghouse service 122, the payment card 102 may then be used as normal at point-of-sale terminals 110 to make purchases only that are within the specified pre-authorization parameters 108. If augmented point-of-sale terminals 110 are available, then these may be used to provide secondary verification of the transactions. For example, different users of the payment card 102 may be provided different security codes or PINs that may be used to allow only those transactions pre-authorized for those identified users. By way of these enhancements, a cardholder may be able to exert more control over use of his or her payment card 102, selectively authorizing only contemplated transactions to ensure proper usage of the payment card 102 by authorized users, and also to avoid fraudulent use of the payment card 102 by others.

In general, computing systems and/or devices, such as the point-of-sale terminal 110, transaction authorization service 114, clearinghouse service 122 and mobile device 128, may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance.

Computing devices, such as the point-of-sale terminal 110, transaction authorization service 114, clearinghouse service 122 and mobile device 128, generally include computer-executable instructions such as the instructions of the pre-authorization application 130, where the instructions may be executable by one or more processors 134. Computer-executable instructions may be compiled or interpreted from computer programs created using a variety of programming languages and/or technologies, including, without limitation, and either alone or in combination, Java™, C, C++, C#, Objective C, Visual Basic, Java Script, Perl, etc. In general, a processor 134 or microprocessor receives instructions, e.g., from a memory 132, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor 134 of a computing device). Such a medium may take many forms, including, but not limited to, non-volatile media and volatile media. Non-volatile media may include, for example, optical or magnetic disks and other persistent memory 132. Volatile media may include, for example, dynamic random access memory 132 (DRAM), which typically constitutes a main memory 132. Such instructions may be transmitted by one or more transmission media, including coaxial cables, copper wire and fiber optics, including the wires that comprise a system bus coupled to a processor 134 of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory 132 chip or cartridge, or any other medium from which a computer can read.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein. The pre-authorization application 130 may be such a computer program product. In some example, the pre-authorization application 130 may be provided as software that when executed by the processor 134 provides the operations described herein. Alternatively, the pre-authorization application 130 may be provided as hardware or firmware, or combinations of software, hardware and/or firmware.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A mobile device comprising:
a card reading device configured to receive account information from a payment card, wherein the account information identifies a user account;
a non-transitory computer readable storage medium configured to store a plurality of instructions and the account information thereon;
a processor configured to implement the plurality of instructions, wherein the plurality of instructions cause the mobile device to:
receive the account information identifying the user account, wherein the account information is received from the card reader;
authenticate the mobile device as authorized to configure pre-authorized transactions for the identified user account;
receive pre-authorization parameters specifying limitations on transactions to be performed using the payment card associated with the user account, the limitations being separate from limitations on use of the payment card specified in a cardholder agreement associated with the payment card; and
provide a pre-authorization request to a transaction authorization server authorizing transactions performed using the payment card, the pre-authorization request including the account information and the pre-authorization parameters.

2. The mobile device of claim 1, the payment card being authorized for use by a plurality of users, the mobile device being associated with one of the plurality of users, the pre-authorization parameters including a first limitation on use of the payment card for transactions requested by a first user of the plurality of users and a second limitation on use of the payment card for transactions requested by a second user of the plurality of users.

3. The mobile device of claim 1, wherein the pre-authorization parameters include at least one of (i) a time limit during which transactions are allowable, (ii) a spending limit within which transactions are allowable, and (iii) a number of transaction limit within which transactions are allowable, such that the pre-authorization of the payment card expires according to the pre-authorization parameters.

4. The mobile device of claim 1, wherein the pre-authorization parameters further include at least one of (i) a limitation on merchant identifiers that are allowable for transactions, (ii) a limitation on merchant categories of goods or services that are allowable for transactions, and (iii) a specification of credentials to be received upon use of the payment card to perform a transaction according to the pre-authorization parameters.

5. The mobile device of claim 1, wherein the plurality of instructions further cause the mobile device to: authenticate the mobile device as authorized to configure pre-authorizations by providing user credentials from the mobile device to a clearinghouse server, wherein the user credentials include at least one of a personal identification number, login information, and a unique identifier associated with the mobile device.

6. The mobile device of claim 1, wherein the card reader device is one of a near field communication device, a magnetic stripe reading device, and an image capture device.

7. The mobile device of claim 1, wherein the plurality of instructions further cause the mobile device to at least one of:
(i) receive a response to the pre-authorization request, and provide an update to a user interface indicative of the response; and
(ii) receive an indication from the transaction authorization service that a transaction was attempted using the payment card, and provide an indication to a user interface of the mobile device indicative of the attempt.

8. The mobile device of claim 1, wherein the plurality of instructions further cause the mobile device to: provide the pre-authorization request to the transaction authorization server over a communications network, without the pre-authorization request traversing a merchant network to which a point-of-sale terminal interacting with the payment card is connected.

9. A method, comprising:
receiving, from a computing device executing a pre-authorization application on a processor of the computing device, account information identifying a user account;
authenticating the computing device as authorized to configure pre-authorized transactions for the identified user account;
receiving pre-authorization parameters specifying limitations on transactions to be performed using a payment card associated with the user account, the limitations being separate from limitations on use of the payment card specified in a cardholder agreement associated with the payment card;
providing a pre-authorization request to a transaction authorization server authorizing transactions performed using the payment card, the pre-authorization request including the account information and the pre-authorization parameters; and
providing, via a biometric scanner in communication with the computing device, biometric information from a user of the payment card to the transaction authorization server, wherein providing the biometric information occurs during a transaction attempt, and wherein the biometric information includes at least one of user thumbprint information, user retinal information, and user image information.

10. The method of claim 9, the payment card being authorized for use by a plurality of users, the computing device being associated with one of the plurality of users, the pre-authorization parameters including a first limitation on use of the payment card for transactions requested by a first user of the plurality of users and a second limitation on use of the payment card for transactions requested by a second user of the plurality of users.

11. The method of claim 9, the pre-authorization parameters including at least one of a time limit during which transactions are allowable, a spending limit within which transactions are allowable, and a number of transaction limit within which transactions are allowable, such that the pre-authorization of the payment card expires according to the pre-authorization parameters.

12. The method of claim 9, the pre-authorization parameters including at least one of a limitation on merchant identifiers that are allowable for transactions, a limitation on merchant categories of goods or services that are allowable for transactions, and specification of credentials to be received upon use of the payment card to perform a transaction according to the pre-authorization parameters, wherein the credentials include at least one of the user thumbprint information, the user retinal information, and a verification of the user image information.

13. The method of claim 9, further comprising authenticating the computing device as authorized to configure pre-authorizations by providing user credentials from the computing device to a clearinghouse server, the user credentials including at least one of a personal identification number, login information, and a unique identifier associated with the computing device.

14. The method of claim 9, further comprising reading the account information identifying the user account from the payment card by a card reader device of the computing device, wherein the computing device is a mobile device.

15. The method of claim 9, further comprising at least one of:
(i) receiving a response to the pre-authorization request, and providing an update to a user interface of the computing device indicative of the response; and
(ii) receiving an indication from the transaction authorization service that a transaction was attempted using the payment card, and providing an indication to a user interface of the computing device indicative of the attempt.

16. The method of claim 9, further comprising providing the pre-authorization request to the transaction authorization server over a communications network, without the pre-authorization request traversing a merchant network to which a point-of-sale terminal interacting with the payment card is connected.

17. A non-transitory computer readable medium storing a pre-authorization software program, the pre-authorization software program being executable by a processor of a mobile device to provide operations comprising:
receiving account information from a card reader of the mobile device that identifies a user account;
authenticating the mobile device as authorized to configure pre-authorized transactions for the identified user account;
receiving pre-authorization parameters specifying limitations on transactions to be performed using a payment card associated with the user account, the limitations being separate from limitations on use of the payment card specified in a cardholder agreement associated with the payment card; and
providing a pre-authorization request to a transaction authorization server authorizing transactions performed using the payment card, the pre-authorization request including the account information and the pre-authorization parameters.

18. The computer readable medium of claim 17, the payment card being authorized for use by a plurality of users, the mobile device being associated with one of the plurality of users, the pre-authorization parameters including a first limitation on use of the payment card for transactions requested by a first user of the plurality of users and a second limitation on use of the payment card for transactions requested by a second user of the plurality of users.

19. The computer readable medium of claim 17, the pre-authorization parameters including at least one of a time limit during which transactions are allowable, a spending limit within which transactions are allowable, and a number of transaction limit within which transactions are allowable, such that the pre-authorization of the payment card expires according to the pre-authorization parameters.

20. The computer readable medium of claim 17, the pre-authorization parameters include (i) a limitation on merchant identifiers that are allowable for transactions, (ii) a limitation on merchant categories of goods or services that are allowable for transactions, and (iii) a specification of credentials to be received upon use of the payment card to perform a transaction according to the pre-authorization parameters, wherein the credentials include at least one of user thumbprint information, user retinal information, and a verification of user image information.

21. The computer readable medium of claim 17, further providing for operations comprising authenticating the mobile device as authorized to configure pre-authorizations by providing user credentials from the mobile device to a clearinghouse server, the user credentials including at least one of a personal identification number, login information, and a unique identifier associated with the mobile device.

22. The computer readable medium of claim 17, further providing for operations comprising reading the account information identifying the user account from the payment card by a card reader device of the mobile device.

23. The computer readable medium of claim 17, further providing for operations comprising at least one of:
(i) receiving a response to the pre-authorization request, and providing an update to a user interface of the mobile device indicative of the response; and
(ii) receiving an indication from the transaction authorization service that a transaction was attempted using the payment card, and providing an indication to a user interface of the mobile device indicative of the attempt.

24. The computer readable medium of claim 17, further providing for operations comprising providing the pre-authorization request to the transaction authorization server over a communications network, without the pre-authorization request traversing a merchant network to which a point-of-sale terminal interacting with the payment card is connected.
